(19) United States
(12) Patent Application Publication
(10) Pub. No.: US 2014/0028683 A1
(43) Pub. Date: Jan. 30, 2014

(54) Methods and software of interactively and dynamically investigating data

(71) Applicant: Jun Luo, Ellicott City, MD (US)

(72) Inventor: Jun Luo, Ellicott City, MD (US)

(21) Appl. No.: 13/557,190

(22) Filed: Jul. 24, 2012

(51) Int. Cl. G06T 11/20

(52) U.S. Cl. 345/440.2; 345/440

(57) ABSTRACT

A software application that users can retrieve data of interest from data sources and review data interactively. The underlying method can be used for databases of general purposes. The underlying method comprises: (i) obtaining data from data sources; (ii) displaying data in two-dimensional multi-node-tree tables; (iii) allowing users to intuitively select any combinations of elements of data tables; (iv) displaying selected data in dynamic and interactive plots. The software application first obtains relevant data from data sources and presents data in two-dimensional multi-node-tree tables. Once users select data elements and choose the operations of data visualization (such as bar plots, curve plots, new tables), then selected data will be displayed either in plots or in new tables. The operations of data visualization provide users with convenient, dynamic and interactive ways of data mining and investigation.

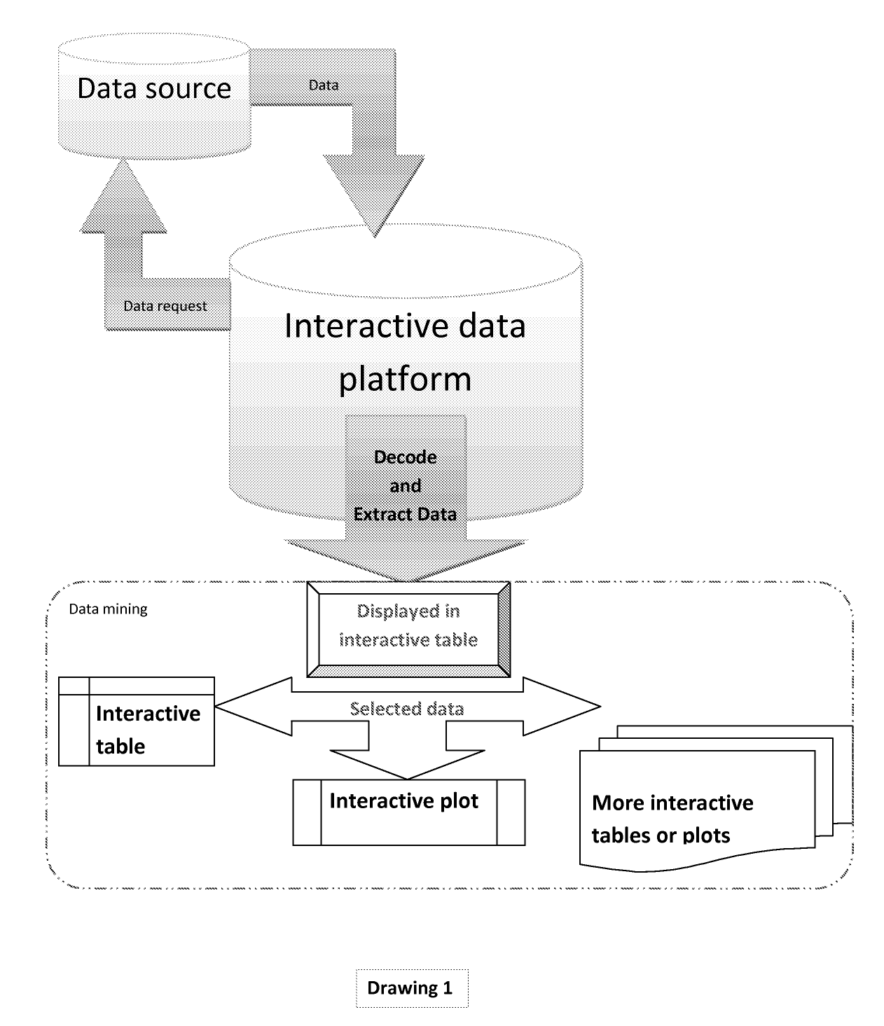

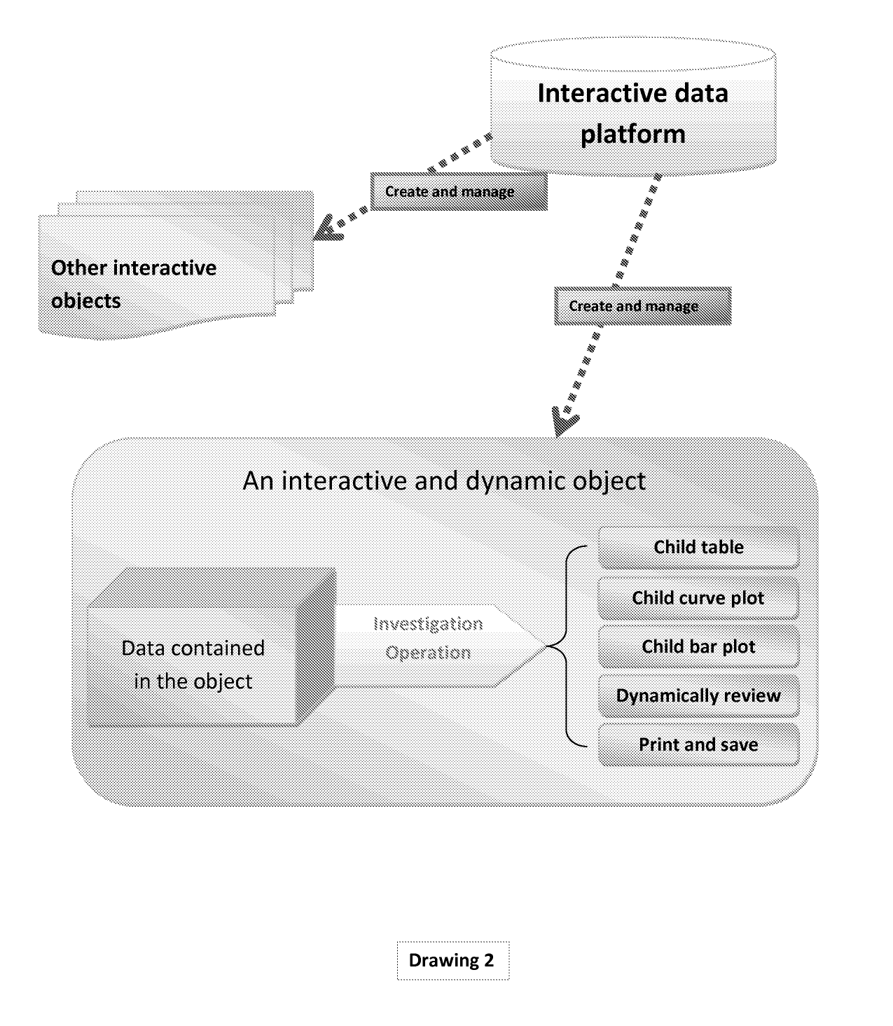

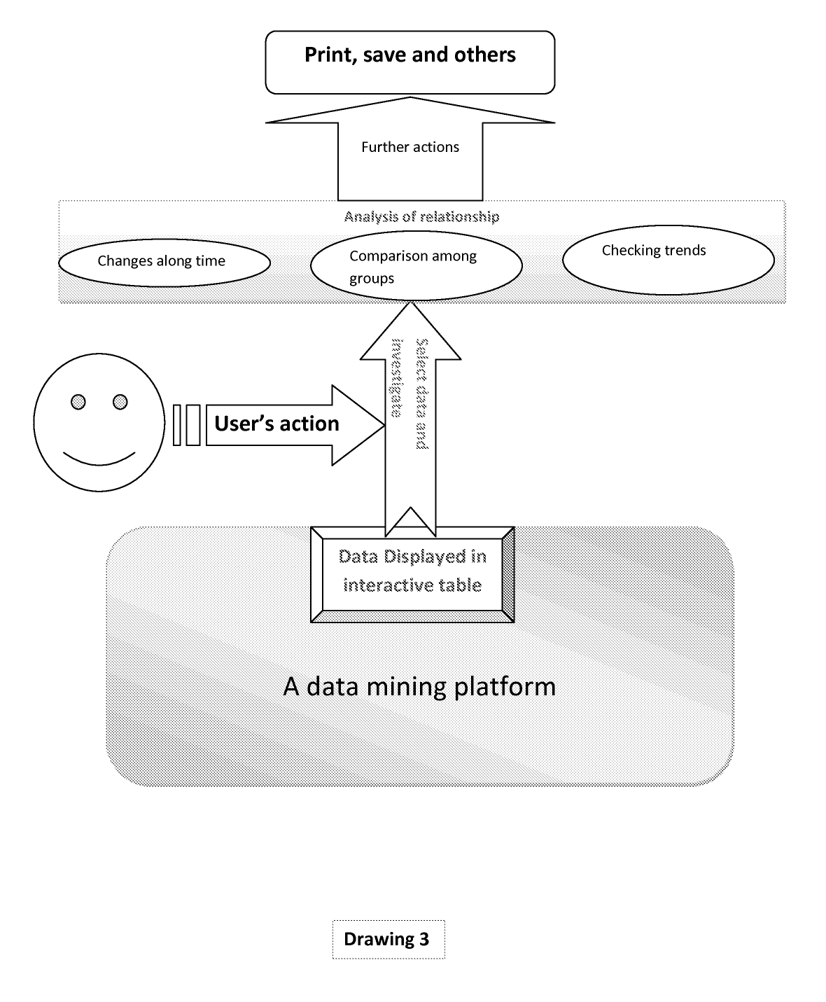

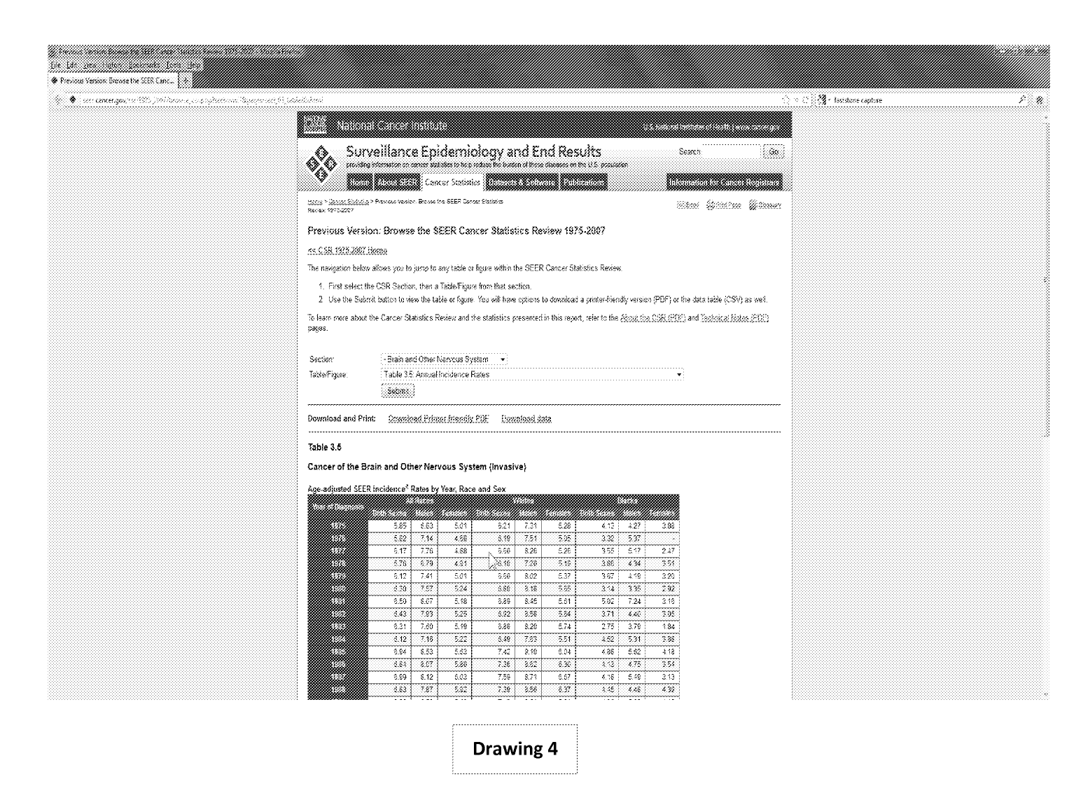

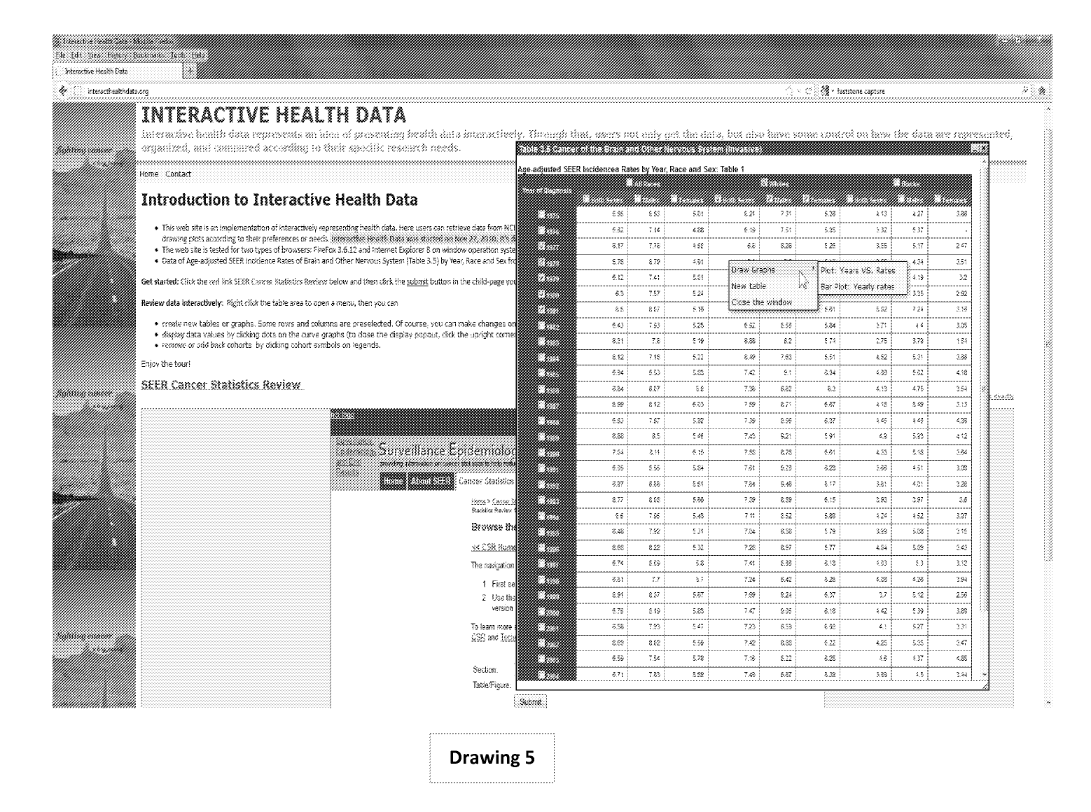

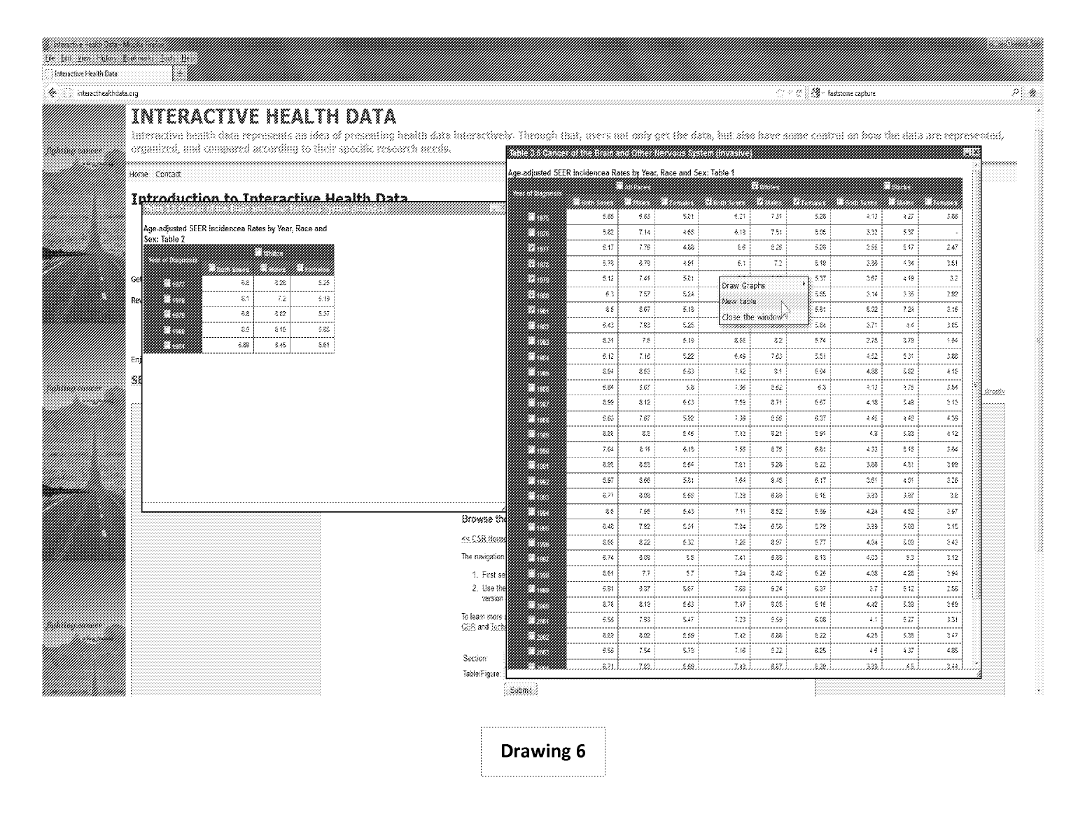

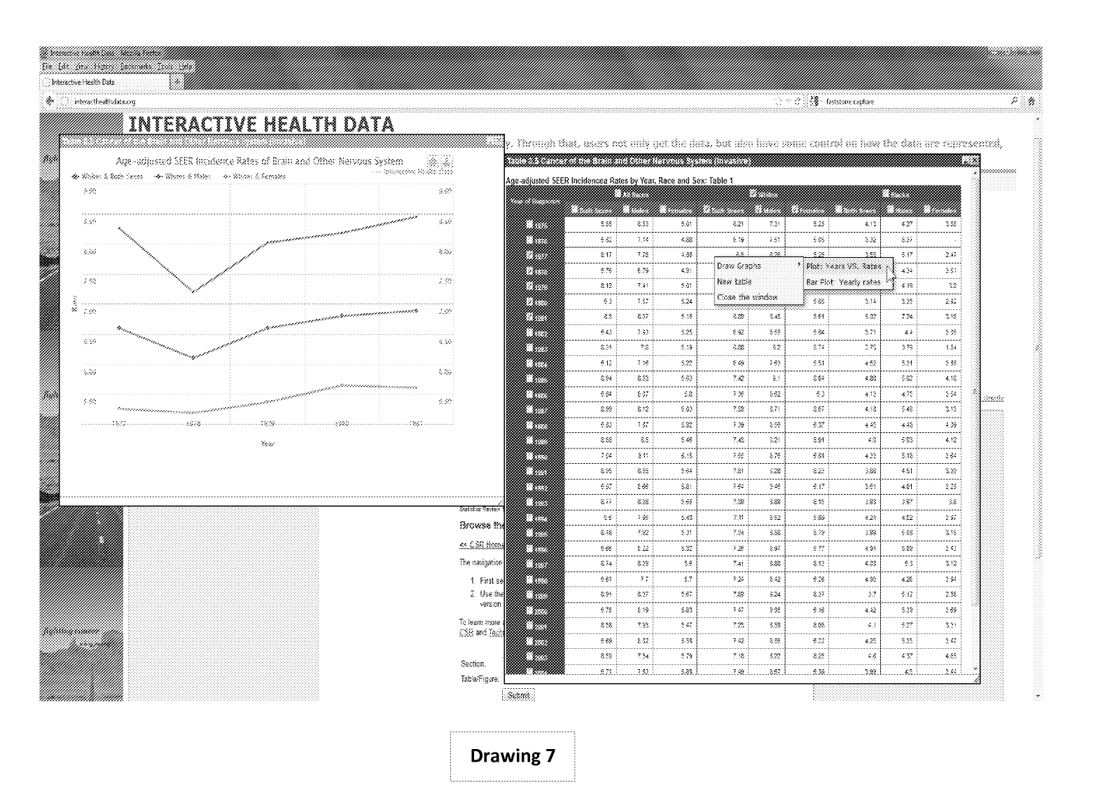

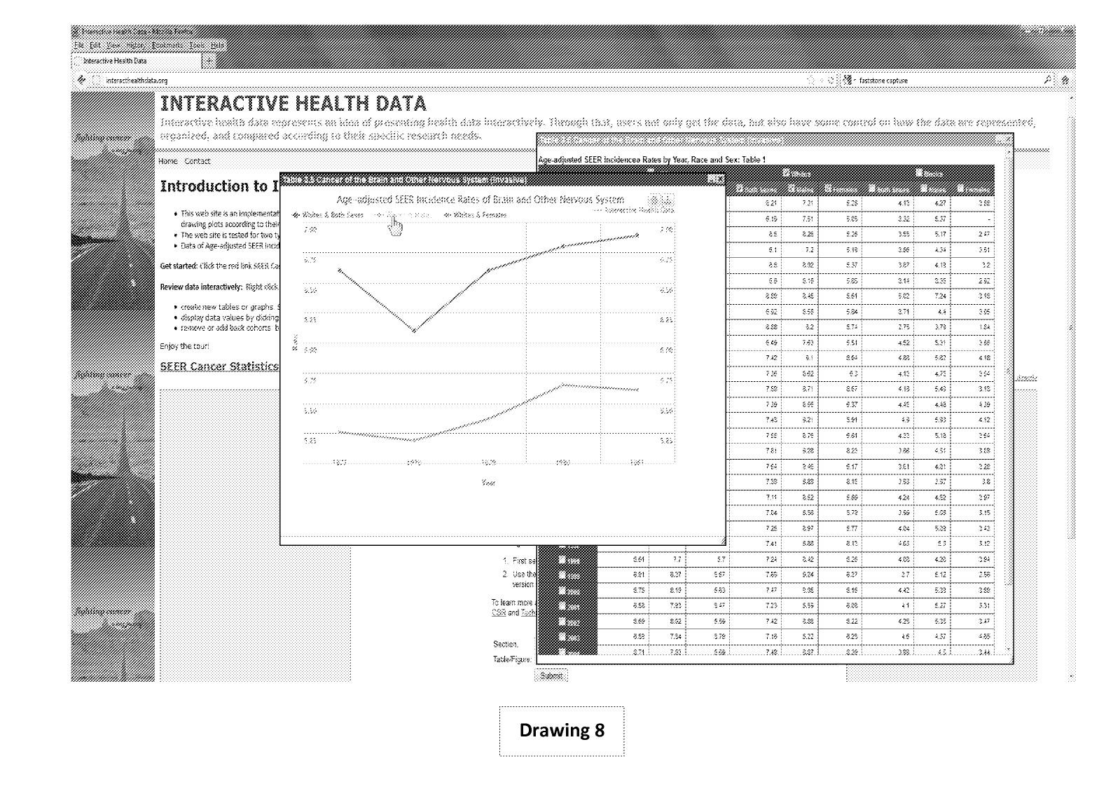

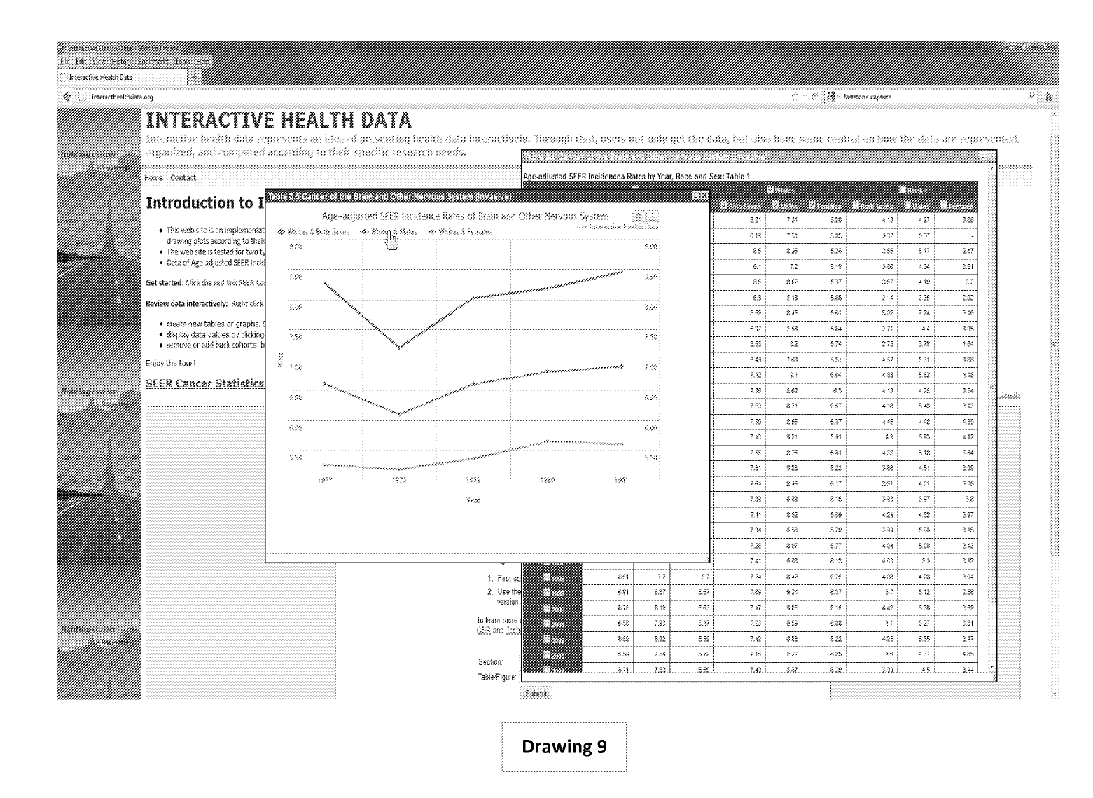

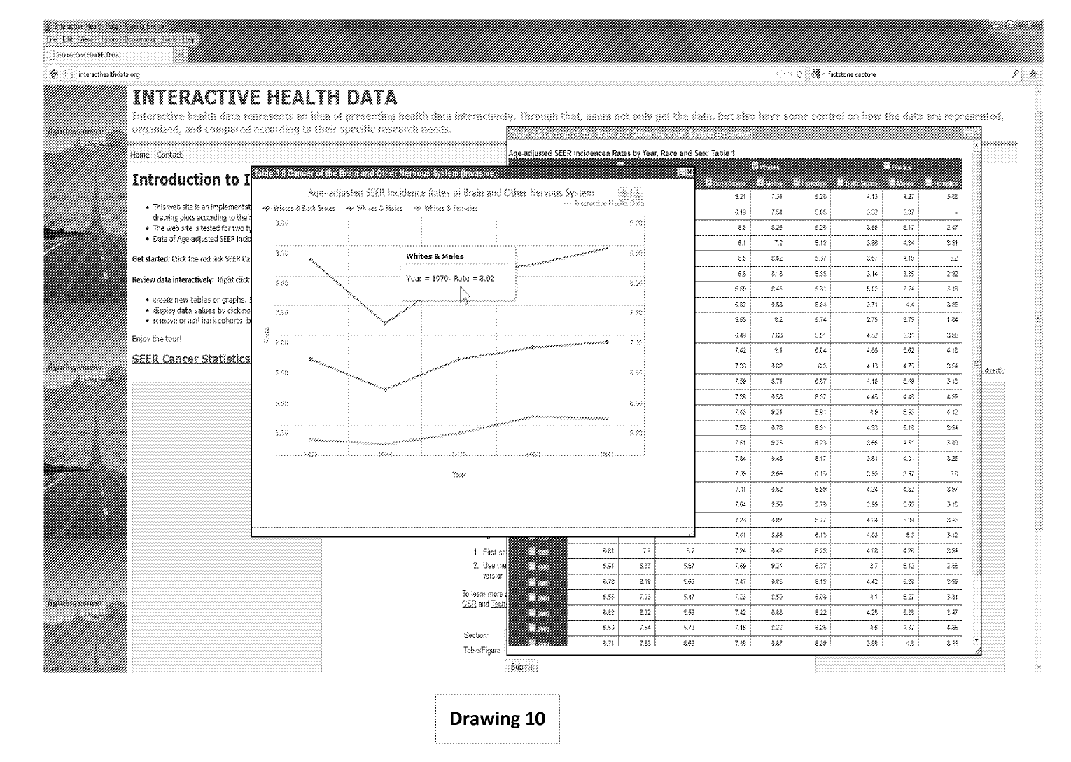

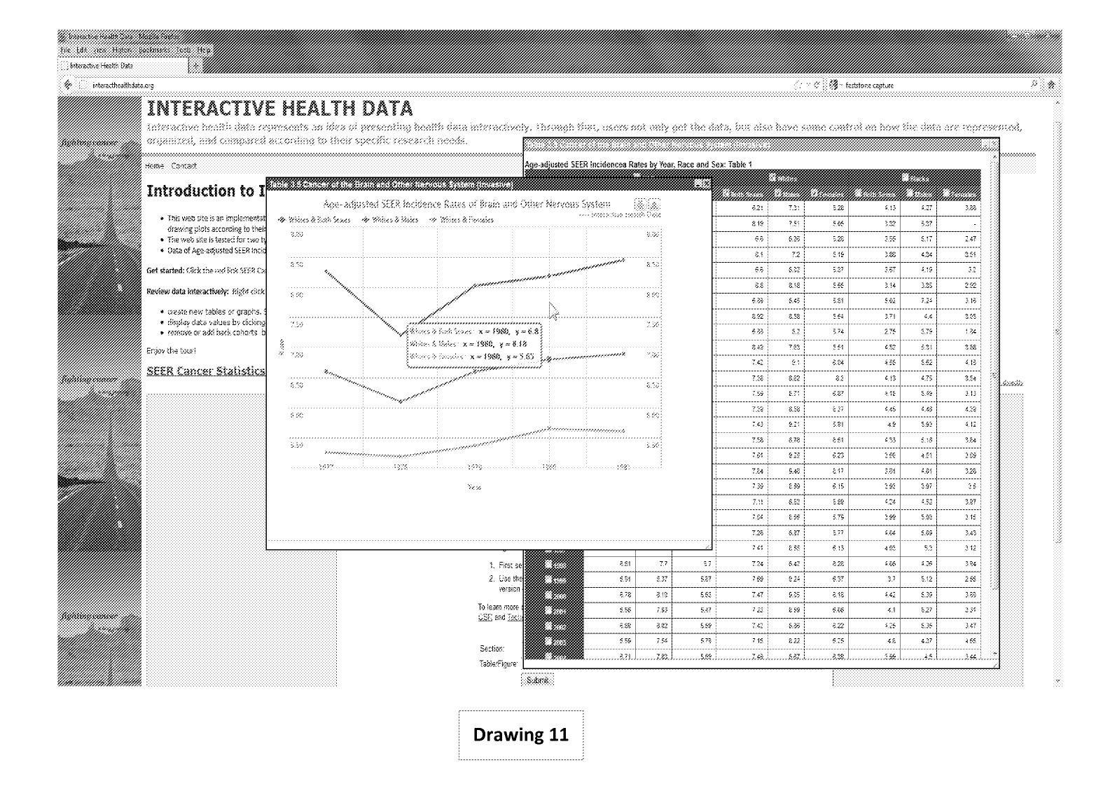

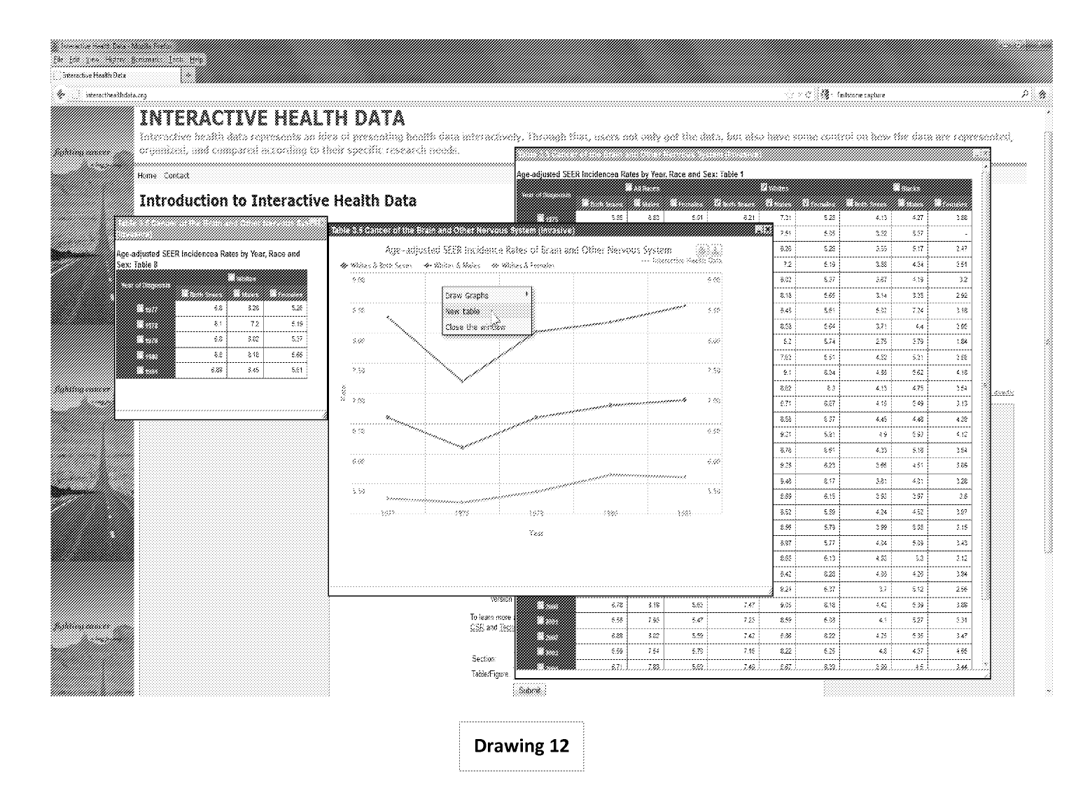

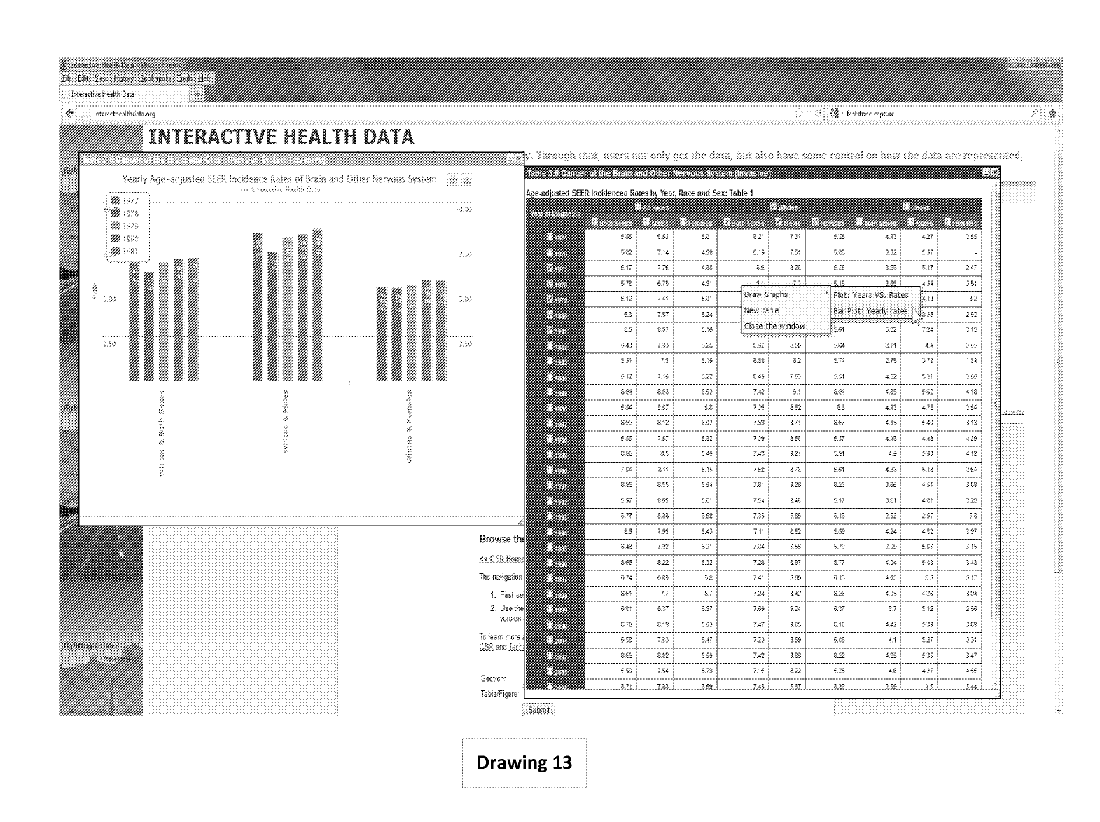

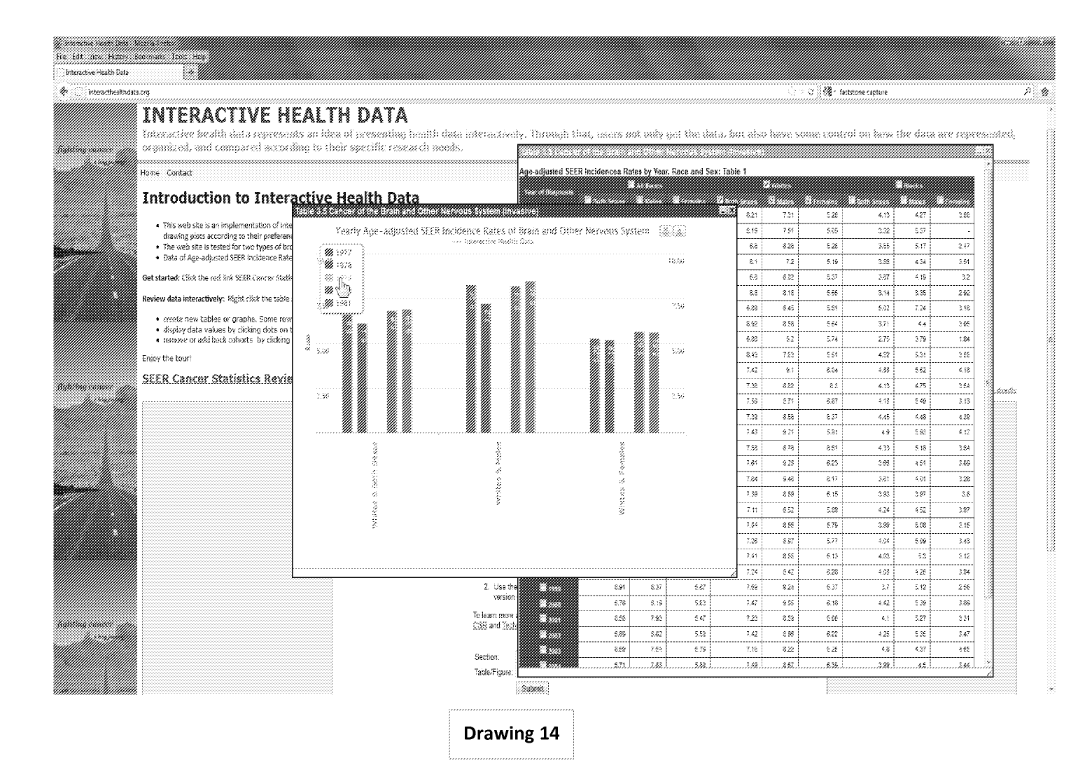

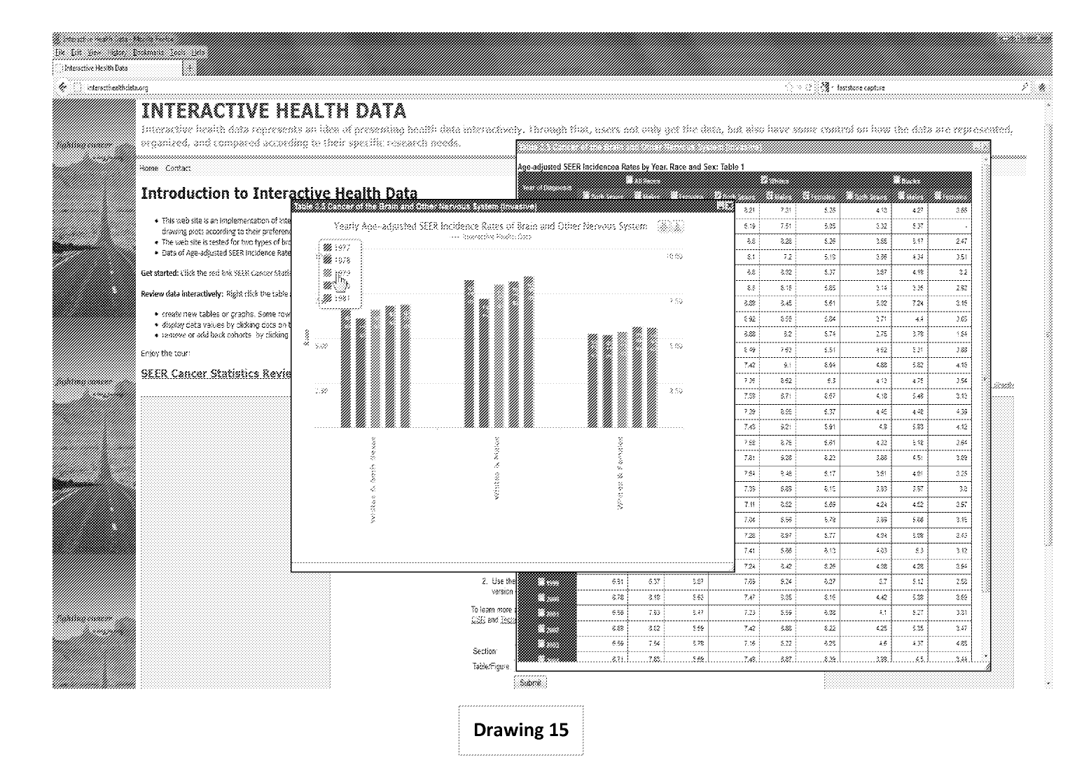

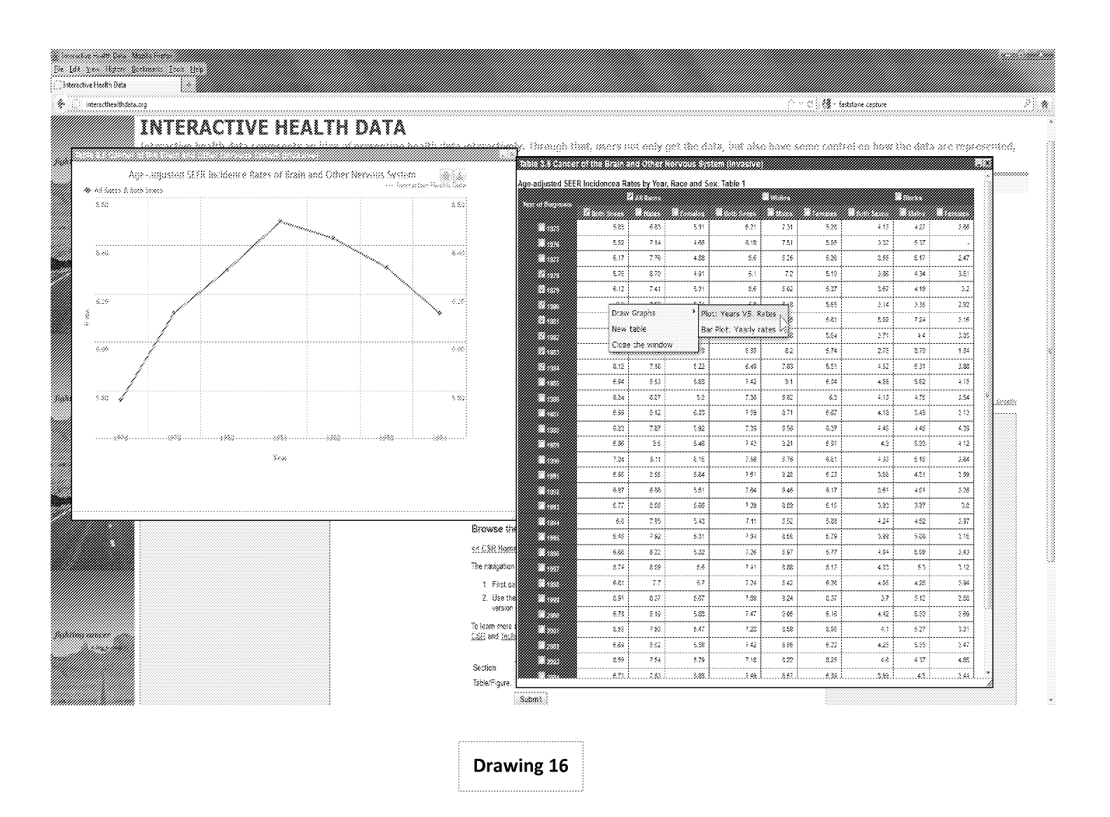

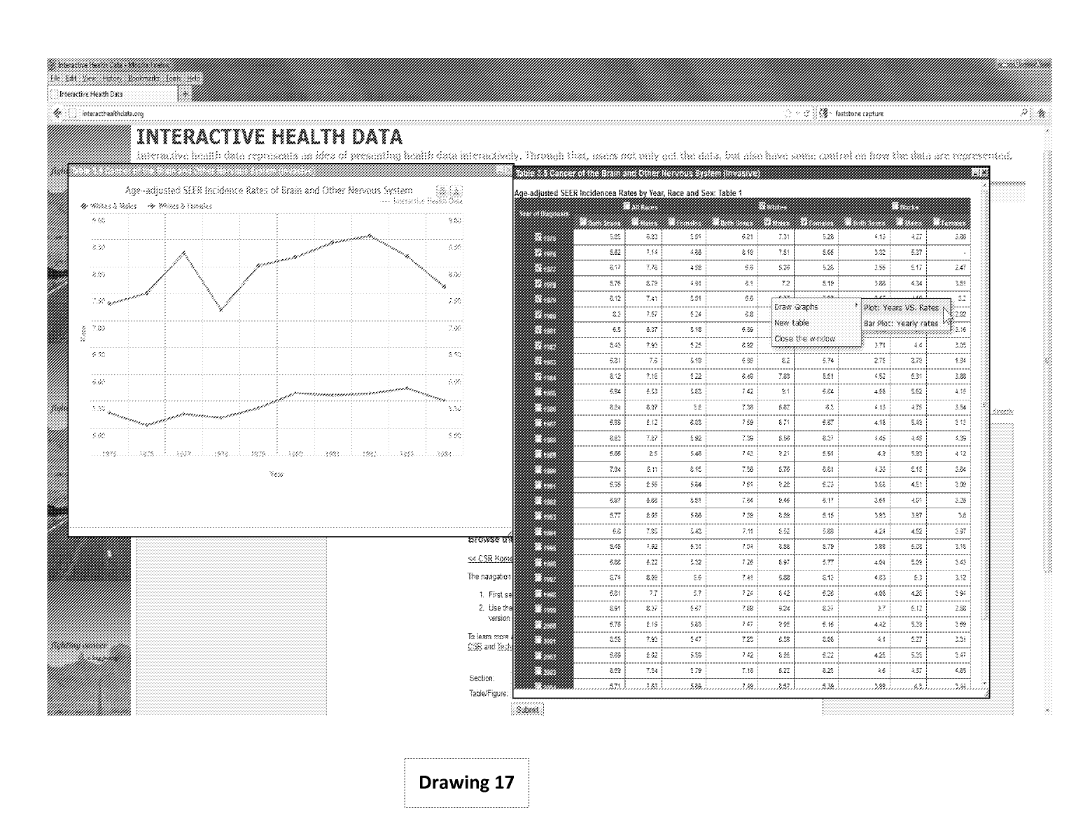

### FIELD OF THE INVENTION

The present invention relates to data visualization and data mining, specifically, providing tools of presenting data in multi-node tree tables and dynamical and interactive graphs, investigating selected data, and data mining.

### BACKGROUND OF THE INVENTION

Displaying and reviewing data are basic tools for research and data mining. The traditional way of displaying and reviewing data is static, i.e. data are organized in a static table and users have to use non-user-friendly statistical or graphing tools to analyze data. One example, in the field of health and medical science, of statically displaying and reviewing data is cancer statistic review provided by National Cancer Institute (NCI). Click the following link to see an example of static health data: http://seer.cancer.gov/csr/1975_{—}2007/browse_csr.php?section=3&page=sect_{—}03_table.05.html

There health data are presented in static tables. Users have no way of doing basic analyses or reviewing data in different format, except for downloading data. It would be handy if the data could be reviewed directly in graphs or in other formats.

The present invention, Interactive health data, represents an idea of presenting data interactively. Instead of getting static health data, users may find it very convenient and tremendous valuable to review health data according to their own needs, i.e. interactively, in any combinations of cohorts, or by variables, in tables or in plots, and more, they could select data of interest and change the outlook of data presentation. Through that, users not only get the data, but also have controls on how the data are presented, organized, and compared according to their specific research needs. This innovative data visualization tool gives users great capability of exploring health data so as to facilitate their research.

The web site www.interacthealthdata.org is an implementation of interactively presenting health data. At this website, users can retrieve data from NCI website (SEER Cancer Statistics Review) and review data in different formats, i.e., creating new tables from old one, drawing plots, and dynamically and interactively reviewing tables or plots according to their needs or preferences.

### SUMMARY OF THE INVENTION

The present invention includes a method and a web application for interactively presenting data and data mining. Aspects of the present invention provide system and methods that enable users to obtaining cancer data from NCI website, displaying the data multi-node tree tables, selecting data of interest, and investigating data of interest dynamically and interactively in tables or plots.

The present invention employs an interactive object model of table or plot. The invention provides users tools for generating and managing interactive and dynamic objects (either table or plot) that are acting as individual show-boxes for investigating data stored in them.

The invention opens the webpage of NCI SEER Cancer Statistics Review in an inline frame and allows users to get data by clicking the submit button on the NCI webpage. A HTML widget will be created inside the main webpage and data from NCI website will be displayed in a table of multi-node trees on both dimensions and all nodes on the trees have a selection check box that are used for selecting data by clicking. The selected data can be reviewed in a new selectable table in a new HTML widget through right-mouse-click menu or be plotted in bar or curve graphs in a new HTML widget through right-mouse-click menu. Graphs can be reviewed interactively and dynamically. Curves or bars can be removed or added through mouse-clicking relevant legends and the axes of graphs will be adjusted automatically. The data points on graphs can be shown through mouse-hovering or mouse-clicking.

Data mining can be intuitively conducted with the present invention. For example, by selecting data of “Age-adjusted SEER Incidence Rates of Brain and Other Nervous System” of all races and both sexes and using the curve plots, it's easy to notice that cancer rate increases on time interval [1978, 1981] while it decreases on [1981, 1984], see Drawing 16. This discovery definitely suggests a research direction of the reason of rising rate, such as pollution. One can also compare cancer rates of two groups of people. For example, by selecting data of “Age-adjusted SEER Incidence Rates of Brain and Other Nervous System” of white male and white female from 1975 to 1984 and using the curve plots, one can easily find that cancer rates are higher for white male than that of white female, see Drawing 17.

These processes of data mining and investigation operations may be repeated a number of times, either on the original data table from NCI website or on the selected data table or graphs.

### BRIEF DESCRIPTION OF THE DRAWING FIGURES

The following drawings and descriptions are provided to illustrate, not to limit the scope of disclosed aspects.

Drawing 1: illustrates a network-based platform for presenting data dynamically and interactively.

Drawing 2: illustrates an interactive and dynamic object model of table or plot.

Drawing 3: illustrates a data mining platform.

Drawing 4: illustrates a static data table on NCI website.

Drawing 5: illustrates an interactive, two-way, and multi-node tree table with selectable checking boxes, on which investigation operations can be applied through right-mouse-click menu.

Drawing 6: illustrates a new table created for selected data.

Drawing 7: illustrated a curve plot generated for selected data.

Drawing 8: illustrated that curves can be removed by clicking the associated legends.

Drawing 9: illustrated that curves can be added by clicking the associated legends.

Drawing 10: illustrated that information of a data point can be displayed by mouse-clicking data points.

Drawing 11: illustrated that the information of all data points on the same vertical line can be displayed through mouse-hovering.

Drawing 12: illustrated that the data contained in a plot object can be extracted into a new table object.

Drawing 13: illustrated a bar plot generated for selected data.

Drawing 14: illustrated that bars can be removed by clicking the associated legends.

Drawing 15: illustrated that bars can be added by clicking the associated legends.

Drawing 16: illustrated an example of data mining showing that cancer rate increases on time interval [1978, 1981] while it decreases on [1981, 1984], by selecting data of “Age-adjusted SEER Incidence Rates of Brain and Other Nervous System” of all races and both sexes and using the curve plots.

Drawing 17: illustrated an example of data mining showing that cancer rates are higher for white male than those of white female, by selecting data of “Age-adjusted SEER Incidence Rates of Brain and Other Nervous System” of white male and white female from 1975 to 1984 and using the curve plots.

The foregoing aspects and embodiments of the present invention will be better understood and appreciated by the following detailed description and the associated drawings.

### DESCRIPTION OF THE PREFERRED EMBODIMENTS

In one embodiment of the present invention, it provides a network-based, communication and operation platform, as shown in Drawing 1, which builds a communication chain with data source, sending data request to and receiving data from data source, extracts data of interest from received data, puts extracted data into an interactive and dynamic table object, handles requests by users, and manages table or plot objects created by users for the corresponding data of selection.

One embodiment of the invention is an interactive and dynamic object model, as demonstrated in Drawing 2, on which interactive and dynamic tables or plots are based. Objects of table or plot are created for data of selection and are independent to each other so that the changes or deletions of objects won't affect others. Objects of table or plot act as interactive show-boxes, which store data of selection, present data of selection in two way multi-node tree table or dynamic plots, and generate child tables or plots for newly selected data according to users' requests.

One embodiment of the invention is a data mining platform, as illustrated in Drawing 3, on which users can investigate data of interest in two way multi-node tree table, select data for further study, make curve plots or bar selected data, detect relationship among selected data groups (e.g. checking the trends of rates by curve plots, adding and removing curves or bars on the plots, or checking information of data points on plots by mouse-hovering or mouse-clicking), and print or save plots.

Instead of receiving static data tables, as shown in Drawing 4, users can retrieve data from NCI website (SEER Cancer Statistics Review) and dynamically and interactively investigating data of interest in tables or plots according to their needs or preferences. The invention opens the webpage of NCI SEER Cancer Statistics Review in an inline frame and allows users to get data by clicking the submit button on the NCI webpage. The data requested will be displayed in a table of multi-node trees on both dimensions and all nodes on the trees have a selection check box that are used for selecting data by clicking, as illustrated in Drawing 5.

As some columns and rows being selected, for example, “Age-adjusted SEER Incidence Rates of Brain and Other Nervous System” of all races and both sexes and years from 1978 to 1984, data of selection can be shown in a new table, as shown in Drawing 6, which is an independent object as described before and can be investigated through operations such as checking values of data elements, further selecting data elements of interest, and drawing curve plots or bar plots for the new selection.

As some columns and rows being selected, for example, “Age-adjusted SEER Incidence Rates of Brain and Other Nervous System” of all races and both sexes and years from 1978 to 1984, data of selection can be shown in an interactive and dynamic curve plot, as shown in Drawing 7, which is an independent object as described before and can be investigated through operations such as dynamically reviewing curves (removing curves by clicking the associated legends (see Drawing 8), adding curves by clicking the associated legends (see Drawing 9), reviewing information of a data point by mouse-clicking data points (see Drawing 10), or reviewing the information of all data points on the same vertical line by mouse-hovering (see Drawing 11)), restoring data elements into a new table (see Drawing 12), further selecting data elements of interest in the new table, and drawing curve plots or bar plots for the new selection.

As some columns and rows being selected, for example, “Age-adjusted SEER Incidence Rates of Brain and Other Nervous System” of all races and both sexes and years from 1978 to 1984, data of selection can be shown in an interactive and dynamic bar plot, as shown in Drawing 13, which is an independent object as described before and can be investigated through operations such as dynamically reviewing curves (removing bars by clicking the associated legends (see Drawing 14), adding bars by clicking the associated legends (see Drawing 15), or reviewing information of a bar by mouse-clicking data points), restoring data elements into a new table, further selecting data elements of interest in the new table, and drawing curve plots or bar plots for the new selection.

Here is an example of conducting a data mining with the present invention: select and display data of “Age-adjusted SEER Incidence Rates of Brain and Other Nervous System” in a two way multi-node tree table; review the data elements in the table and determine to investigate the changes of cancer rates for all races and both sexes in years [1978, 1984]; select data columns of (all races, both sexes) and data rows of [1978, 1984] and create a curve plot for the selection through right-mouse-click menu; review the curve and find that cancer rate increases on time interval [1978, 1981] while it decreases on [1981, 1984], see Drawing 16; print the plot or save the plot in any of 4 formats (png, jpeg, pdf, and svg), through mouse-clicking relevant buttons; consider future research on the reason of the increment of cancer rate; review the data elements again and determine to compare cancer rates of white male and white female from 1975 to 1984; select data columns of white male and white female and data rows of [1975, 1984] and create a curve plot for the selection through right-mouse-click menu; review the curves and find that that cancer rates are higher for white male than those of white female, see Drawing 17; print the plot or save the plot in any of 4 formats (png, jpeg, pdf, and svg), through mouse-clicking relevant buttons;

What is claimed is:

1. A method of dynamically and interactively presenting and investigating data, comprising: displaying data in two dimensional tables with key words arranged in multi-node trees on each dimension; displaying data in selectable columns and rows; creating new tables containing selected data; generating curve plots of selected data; generating bar plots of selected data; reviewing data of new tables, further selecting data of interest, and creating tables or graphs for the selection; dynamically and interactively reviewing curve plots or bar plots and extracting data that are shown in the plots;

2. A method according to claim 1, wherein the data are organized collections of information in entity-relationship structure.

3. A method according to claim 1, wherein categorical variables are displayed in multi-node trees on both dimensions of the table (i.e. columns and rows).

4. A method according to claim 1, wherein all nodes on the trees have a check box that are used for selecting data.

5. A method according to claim 1, wherein a new table containing selected data can be created in a new window through right-mouse-click menu.

6. A method according to claim 5, wherein the new table has its own data structure, data elements of which can be selected and more tables or graphs can be generated for the selection.

7. A method according to claim 1, wherein a curve plot or bar plot displaying selected data can be created in a new window through right-mouse-click menu.

8. A method according to claim 7, wherein the curve plot or bar plot has its own data structure and data can be restored into a table in a new window, data elements of which can be selected and more tables or graphs can be generated for the selection.

9. A method according to claim 7, wherein the curve plot or bar plot can be printed or saved in any of 4 formats (png, jpeg, pdf, and svg), through mouse-clicking relevant buttons.

10. A method according to claim 7, wherein the curve plot or bar plot can be reviewed dynamically and interactively, through mouse-hovering or mouse-clicking data points.

11. A method according to claim 7, wherein the curve plot or bar plot can be modified dynamically and interactively, through adding or removing curves by mouse-clicking relevant legends.

12. A method according to claim 11, wherein the axes of curve plot or bar plot will be adjusted automatically when adding or removing curves by mouse-clicking relevant legends.

13. A network-based system comprising: send, to database server (e.g. NCI CSR server), data requests; receive, from database server, the requested data of certain format; extract data of interest; display data of interest in two dimensional tables with key words arranged in multi-node trees on each dimension.

14. The system in claim 13, wherein the database is a general database management system.

15. A method of interactive object model comprising: hold data of interest; provide interactive tools of interactively and dynamically investigating data in different formats; from any object, child objects that contain subsets of data can be generated.

16. A platform of data mining comprising: hold data of interest; provide tools to reorganize data, e.g. selecting columns or rows of data; provide interactive tools of interactively and dynamically investigating data in tables or graphs; print or save tables or plots that show the detected relationship.

17. Interactive tools according to claim 16 comprising: two way multi-node tree tables; interactive and dynamic curve plots or bar plots; functions of adding and removing curves or bars on the plots to investigate the relationship among cohorts; functions of displaying information of data points on plots by mouse-hovering or mouse-clicking.
